(19) United States
(12) Patent Application Publication
(10) Pub. No.: US 2005/0116438 A1
(43) Pub. Date: Jun. 2, 2005

(54) Bicycle with two pedaling modes

(76) Inventors: Chien Kuo Wang, Hsinchuang City (TW); Chien Min Wang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/724,139

(22) Filed: Dec. 1, 2003

(51) Int. Cl. B62K 11/00

(52) U.S. Cl. 280/210

(57) ABSTRACT

A bicycle provides two pedaling modes for increasing more pedaling interest. The bicycle has a bicycle body, a rotating shaft tube, two cranks and two pedals. The bicycle body has two handlebars respectively disposed on right and left sides thereof, two wheels respectively disposed on front and rear sides thereof and a seat disposed between the two wheels. The two cranks respectively are connected to two ends of the rotating shaft structure and the two pedals respectively are connected to the two cranks. The rotating shaft tube has a rotating shaft structure and a mode change apparatus. The mode change apparatus is used for changing pedaling modes.

### BACKGROUND OF THE INVENTION

1. Field of The Invention

The present invention relates to a bicycle, more particularly to a bicycle with two pedaling modes, which has two pedals disposed opposite each other or arranged in the same position, so that a rider can pedal the bicycle in two different pedaling modes.

2. Description of The Related Art

Many people have started to emphasize quality of life, so they often like to ride a conventional bicycle in their free time.

However, the conventional bicycle has two pedals disposed opposite each other and the two pedals are pedaled in a rotating manner. The action of pedaling the bicycle is invariable and boring.

### SUMMARY OF THE INVENTION

The purpose of the present invention is to provide a bicycle with two pedaling modes for increased interest.

In order to achieve above objective, the present invention is to provide a bicycle with two pedaling modes. The bicycle has a bicycle body, a rotating shaft tube, two cranks and two pedals. The bicycle body has two handlebars respectively disposed on right and left sides thereof, two wheels respectively disposed on front and rear sides thereof and a seat disposed between the two wheels.

The rotating shaft tube is disposed below the bicycle body for driving the two wheels and the rotating shaft tube has a rotating shaft structure and a mode change apparatus. The two cranks are respectively connected to two ends of the rotating shaft structure and the two pedals are respectively connected to the two cranks.

The rotating shaft structure includes a shaft unit, a first spring, a first sleeve, a second spring and a second sleeve. The shaft unit has a shaft portion, a first tail portion and a second tail portion respectively extending from two ends of the shaft portion, a wedge-shaped portion formed on an outer circumference of the first tail portion, and a washer disposed at a free end of the first tail portion. One crank is engaged with the second tail portion. The first spring encloses the shaft portion of the shaft unit and has a first circular portion and a second portion respectively formed on two sides thereof. The first sleeve has a hollow sleeve body and a mating wedge-shaped portion formed on an inner circumference of the hollow sleeve body for mating with the corresponding wedge-shaped portion. Another crank is engaged with the first sleeve. The second spring encloses the first tail portion.

The mode change apparatus includes a bar and a controller controlling the bar for changing pedaling modes.

It is to be understood that both the foregoing general description and the following detailed description are exemplary, and are intended to provide further explanation of the invention as claimed.

Other advantages and features of the invention will be apparent from the following description, drawings and claims.

### BRIEF DESCRIPTION OF THE DRAWINGS

These and other features, aspects, and advantages of the present invention will become better understood with regard to the following description, appended claims, and accompanying drawings, where:

FIG. 1 is an exploded view of the present invention;

FIG. 2 is a partially magnified view of FIG. 1;

FIG. 3 is combined view of the mode change apparatus;

FIG. 4 is a perspective view of the first pedaling function of the present invention;

FIG. 5 is a cross-sectional view of the rotating shaft tube;

FIG. 6 shows a first action of the rotating shaft tube;

FIG. 7 shows a second action of the rotating shaft tube; and

FIG. 8 is a perspective view of the second pedaling function of the present invention.

### DETAILED DESCRIPTION OF PREFERRED EMBODIMENTS

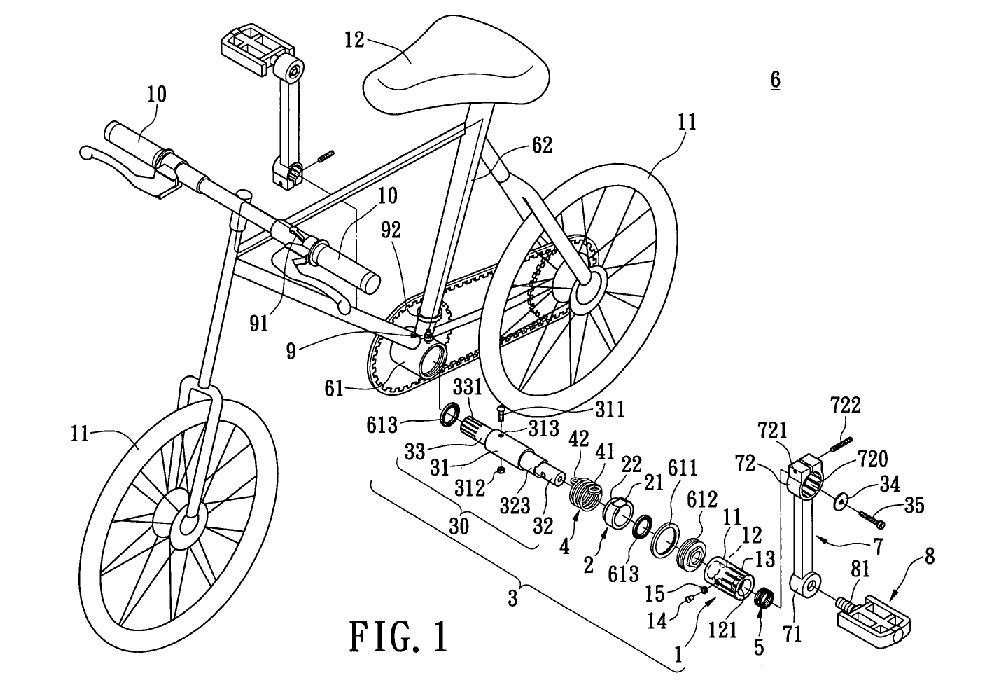

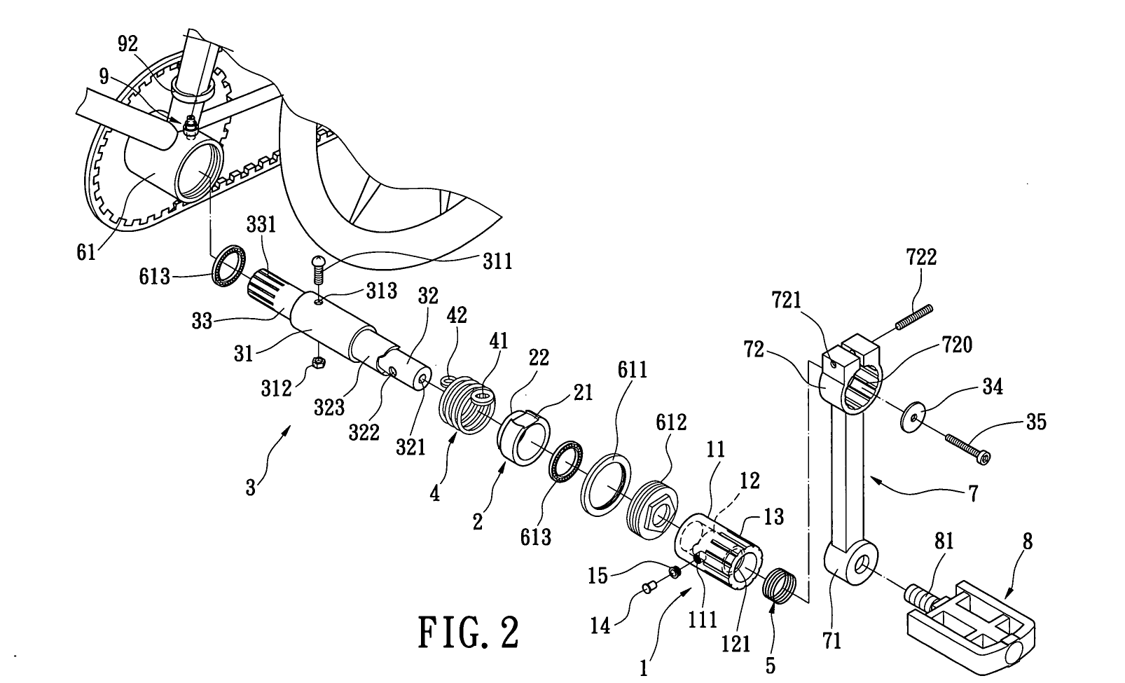

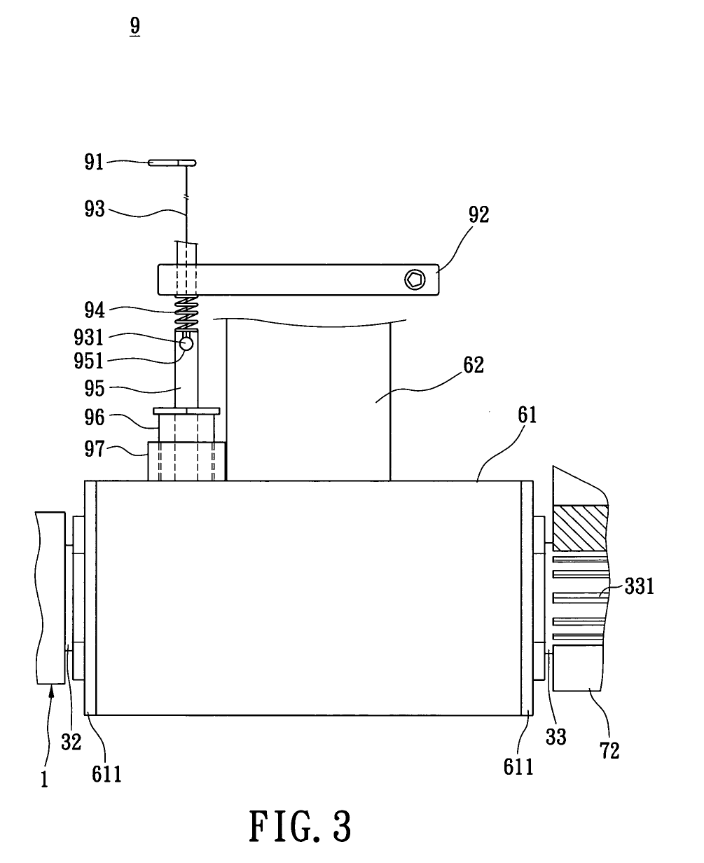

Referring to FIG. 1-5, the present invention provides a bicycle 6 with two pedaling modes. The bicycle 6 has a bicycle body 62, a rotating shaft tube 61 disposed below the bicycle body 62, two cranks 7 and two pedals 8.

The bicycle body 62 has two handlebars 10 respectively disposed on right and left sides thereof, two wheels 11 respectively disposed on front and rear sides thereof and a seat 12 disposed between the two wheels 11.

The rotating shaft tube 61 is disposed below the bicycle body 62 for driving the two wheels 11. The rotating shaft tube 61 has a rotating shaft structure 3 and a mode change apparatus 9. The two cranks 7 are respectively connected to two ends of the rotating shaft structure 3 and the two pedals 8 are respectively connected to the two cranks 7.

Referring to FIGS. 1, 2, 5, the rotating shaft structure 3 includes a shaft unit 30, a first spring 4, a first sleeve 1, a second spring 5 and a second sleeve 2. The shaft unit 30 includes a shaft portion 31, a first tail portion 32 and a second tail portion 33 respectively extending from two ends of the shaft portion 31, and a wedge-shaped portion 323 formed on an outer circumference of the first tail portion 32. The shaft portion 31 further includes a screw member 311, a nut 312 and a through hole 313 formed near the second tail portion 33. The screw member 311 is inserted through the through hole 313 and then secured by the nut 312. The first tail portion 32 further defines an axial hole 321 axially formed, and a longitudinal hole 322 longitudinally formed. The wedge-shaped portion 323 has concave sections and convex sections formed therein. The second tail portion 33 has a plurality of second flutes 331 axially formed thereon.

The first spring 4 has a first circular portion 41 and a second circular portion 42 respectively formed on two sides thereof. The first spring 4 encloses the shaft portion 31 of the shaft unit 30 and the second circular portion 42 corresponds with the through hole 313. Furthermore, the screw member 311 is inserted through the second circular portion 42 and the through hole 313 and then secured by the nut 312, so that the first spring 4 is secured on the shaft portion 31.

The second sleeve 2 encloses the shaft portion 31 of the shaft unit 30. The second sleeve 2 has a concavity 21 formed in a top thereof and a hollow protruding block 22 formed on a side thereof. The first circular portion 41 of the first spring 4 is received in the concavity 21 thereby to form a step difference.

The first sleeve 1 has a hollow sleeve body 11, a mating wedge-shaped portion 12 corresponding to the wedge-shaped portion 323 and formed on an inner circumference of the hollow sleeve body 11, a plurality of first flutes 13 axially formed thereon, a key hole 111 longitudinally formed through the sleeve body 11, a key sleeve 15 engaging to the key hole 111, and a key 14 engaging with the key sleeve 15. The first sleeve 1 encloses the first tail portion 32 and the mating wedge-shaped portion 12 of the first sleeve 1 has concave sections and convex sections formed therein for mating with the wedge-shaped portion 323. The mating wedge-shaped portion 12 further has a holding portion 121 on an end thereof.

After the first sleeve 1 encloses the first tail portion 32, the first tail portion 32 is inserted through the inner of the hollow sleeve body 11 of the first sleeve 1. The second spring 5 proceeds to enclose the first tail portion 32 and abuts against between the holding portion 121 of the mating wedge-shaped portion 12 and the washer 34. The washer 34 abuts against the second spring 5; moreover, a screw 35 is inserted through the washer 34 and engages the axial hole 321 so that the wedge-shaped portion 323 and the mating wedge-shaped portion 12 are able to be elastically separated and mated by the second spring 5.

The key hole 111 corresponds to the longitudinal hole 322 of the first tail portion 32 and the key 14 is inserted through the key hole 111 and the longitudinal hole 322 for limiting action of the wedge-shaped portion 323 and the mating wedge-shaped portion 12.

The rotating shaft structure 3 is received in the rotating shaft tube 61; moreover the rotating shaft tube 61 includes two hollow caps 612, two ball bearings 613 and two fixing rings 611.

The two hollow caps 612 with an external thread are respectively engaged with two ends of the rotating shaft tube 61. Each of the caps 612 defines a receiving space in a side thereof for receiving a ball bearing 613. The two ball bearings 613 are respectively disposed in the two receiving spaces of the two caps 612 and the two ball bearings 613 are respectively enclosed the first tail portion 32 and the second tail portion 33, so that the rotating shaft structure 3 rotates freely. The two fixing ring 611 are respectively engaged with the cap 612 for fixing the cap 612.

Each crank 7 has a joint 71 and a C-shaped jig 72 respectively disposed on two sides thereof Each pedal 8 has a handle 81 with a thread. The two joints 71 are respectively engaged to the two handles 81. Each C-shaped jig 72 has a plurality of mating teeth 720 formed on an inside thereof and respectively engaged with the second flutes 331 of the second tail portion 33 and the first flutes 13 of the first sleeve 1. Each C-shaped jig 72 further has two corresponding screw holes 721 formed therein and a bolt 722 screwing through the two corresponding screw holes 721 so that the C-shaped jig 72 is tightened or loosened by the bolt 722. Therefore, the rotating shaft structure 3 is rotated by the pedal 8 through the crank 7.

Referring to FIGS. 1, 3, 5, the mode change apparatus 9 includes a controller 91, a clip 92, cable 93, a block 931, an elastic element 94, a bar 95, a bar sleeve 96, and a hollow base 97. The controller 91 is disposed on one handlebar of the bicycle 6 for controlling the bar 95. The cable 93 connects the controller 91 to the bar 95, and the cable 93 is further fixed on the bicycle body 62 of the bicycle 6 by the clip 92. The bar 95 defines an aperture 951 formed in an end thereof. The block 931 is mounted in the aperture 951. The elastic element 94 is disposed between the clip 92 and the bar 95; moreover, the elastic element 94 abuts the clip 92 and the bar 95 for elastically driving the bar 95 downward. The bar 95 is inserted in the rotating shaft tube 61 for alternatively inserting into the first circular portion 41 of the first spring 4. The base 97 is disposed on the rotating shaft tube 61. The mode change apparatus 9 further includes a bar sleeve 96 with an internal thread engaged with the base 97 with an external thread.

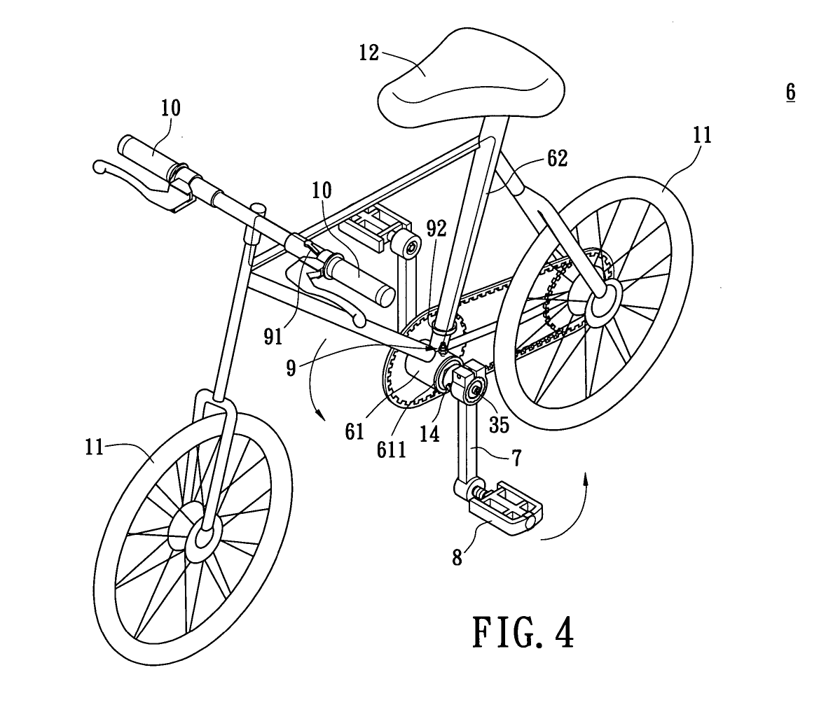

Reference is made to FIG. 4, which illustrates the first pedaling function of the bicycle 6. Controller 91 of the mode change apparatus 9 is used to pull the bar 95 upward, so that the bar 95 is not inserted into the first circular portion 41 of the first spring 4, the first spring 4 rotates freely and does not create a torsion. Therefore a rider can repeatedly pedal the two pedals 8 of the bicycle 6 in 360 degrees.

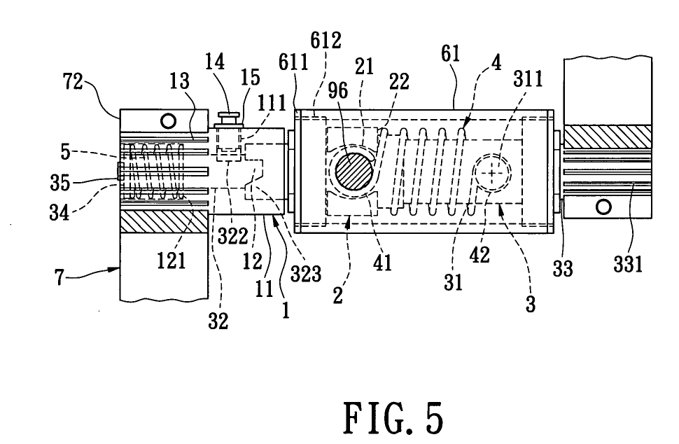

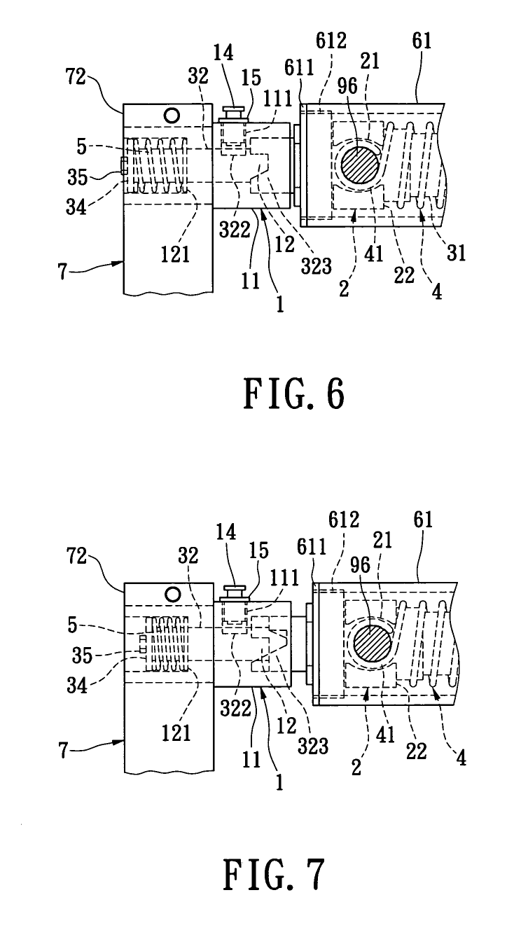

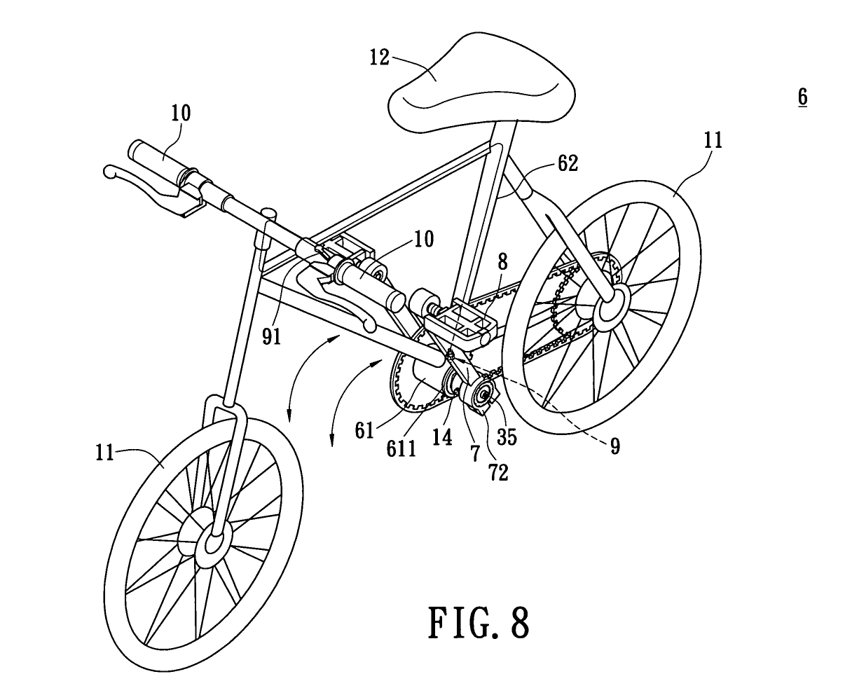

Reference is made to FIGS. 5-8, which illustrate the second pedaling function of the bicycle 6.

First, the controller 91 of the mode change apparatus 9 is used to drive the bar 95 downward and abut against an outside of the second sleeve 2.

Second, the rider pushes the left pedal 8 with his/her left foot to retain the left pedal in a lower position.

Third, the rider pushes the right pedal 8 into the lower position. When the left pedal 8 is maintained in the low position or the right pedal 8 is just pushed, the bar 95 is exactly pushed into the first circular portion 41 of the first spring 4 by the elastic element 94. Furthermore, when the first circular portion 41 of the first spring 4 is received in-the concavity 21 to form a step difference thereby, the step difference makes the bar 95 insert exactly into the first circular portion 41 of the first spring 4. Therefore, as the right pedal 8 is pedaled into the lower position, the wedge-shaped portion 323 and the mating wedge-shaped portion 12 are relatively separated and then mated again so that the first spring 4 stores a elastic force by twisting. In first pedaling function, the left pedal 8 and the right pedal 8 are disposed opposite each other. At this moment, the left pedal 8 and the right pedal 8 are in the same position.

Fourth, the rider releases the force of his/her two feet on the right pedal 8 and the left pedal 8. The right pedal 8 and the left pedal 8 are then moved to an upper position by elastic force of the twisted first spring 4.

After performing the above steps, the rider continues to tread downwardly on the left pedal 8 and the right pedal 8, after which the left pedal 8 and the right pedal 8 are returned to the upper position by the elastic force of the twisted first spring 4 so that the bicycle 6 is driven forward.

When the rider wants to change to the first pedaling mode, s/he uses the mode change apparatus 9 to pull the bar 95 back. The left pedal 8 is held, and then the right pedal 8 is pushed down until the right pedal 8 and the left pedal 8 are in opposite positions.

According to above description, the present invention has the following advantages:
(1) The bicycle 6 provides two pedaling modes so that pedaling the bicycle becomes more interesting.
(2) In accordance with requirement of the rider, the first spring 4 can be replaced by other types with different elastic forces.
(3) When the rider pedals the bicycle 6 on an uneven road, the key 14 is inserted into the longitudinal hole 322 so that the wedge-shaped portion 323 and the mating wedge-shaped portion 12 are not relatively separated and mated.

Therefore, the foregoing is considered as illustrative only of the principles of the invention. Further, since in the art, it is not desired to limit the invention to the exact construction and operation show and described, and accordingly, all suitable modifications and equivalents may be resorted to, falling within the scope of the invention.

1. A bicycle with two pedaling modes, comprising:
a bicycle body having two handlebars respectively disposed on right and left sides thereof, two wheels respectively disposed on front and rear sides thereof and a seat disposed between the two wheels;
a rotating shaft tube disposed below the bicycle body for driving the two wheels and the rotating shaft tube having a rotating shaft structure and a mode change apparatus, wherein the rotating shaft structure includes:
a shaft unit having a shaft portion, a first tail portion and a second tail portion respectively extending from two ends of the shaft portion, a wedge-shaped portion formed on an outer circumference of the first tail portion and a washer disposed at a free end of the first tail portion;
a first spring enclosing the shaft portion of the shaft unit, the first spring having a first circular portion and a second circular portion respectively formed on two sides thereof;
a first sleeve having a hollow sleeve body and a mating wedge-shaped portion formed on an inner circumference of the hollow sleeve body, the mating wedge-shaped portion mating with the corresponding wedge-shaped portion; and
a second spring enclosing the first tail portion and abutting against between an end of the mating wedge-shaped portion and the washer; and wherein the mode change apparatus includes a bar inserted in the rotating shaft tube for alternatively inserting into the first circular portion of the first spring and a controller for controlling the bar;
two cranks respectively connecting to the first sleeve and the second tail portion; and
two pedals respectively connecting to the two cranks.

2. The bicycle with two pedaling modes as claimed in claim 1, wherein the wedge-shaped portion and the mating wedge-shaped portion each have concave sections and convex sections alternatingly to mate with each other.

3. The bicycle with two pedaling modes as claimed in claim 1, wherein the rotating shaft structure further includes a second sleeve enclosing the shaft portion of the shaft unit, and the second sleeve has a concavity corresponding to the bar, the concavity receiving the first circular portion of the first spring for insertion of the bar.

4. The bicycle with two pedaling modes as claimed in claim 1, wherein the rotating shaft tube further includes two hollow caps with an external thread respectively engaging with two ends of the rotating shaft tube, two ball bearings respectively enclosing the first tail portion and the second tail portion, and two fixing rings with an internal thread respectively engaging with the two caps.

5. The bicycle with two pedaling modes as claimed in claim 1, wherein the mode change apparatus further includes a cable connecting the controller to the bar, a clip clamping the cable against the bicycle and an elastic element enclosing the cable and elastically abutting against the clip and the bar.

6. The bicycle with two pedaling modes as claimed in claim 1, wherein the second tail portion has a plurality of second flutes axially formed thereon, the first sleeve has a plurality of first flutes axially formed thereon, each of the two cranks has a jig disposed on a side thereof, and each of the two jigs has a plurality of mating teeth formed on an inside thereof for respectively engaging with the second flutes of the second tail portion and the first flutes of the first sleeve.

7. The bicycle with two pedaling modes as claimed in claim 6, wherein a jig with a C-shape further has two corresponding screw holes respectively formed thereon and a bolt screwing through the two corresponding screw holes so that the jig is tightened or loosened by the bolt.

8. The bicycle with two pedaling modes as claimed in claim 1, wherein a mating wedge-shaped portion of the first sleeve is of a hollow shape.
